(19) United States
(12) Patent Application Publication
(10) Pub. No.: US 2025/0340361 A1
(43) Pub. Date: Nov. 6, 2025

(54) PEAK SHAVING SYSTEM FOR A VOCATIONAL VEHICLE

(71) Applicant: Oshkosh Corporation, Oshkosh, WI (US)

(72) Inventor: Derek Wente, Austin, MN (US)

(73) Assignee: Oshkosh Corporation, Oshkosh, WI (US)

(21) Appl. No.: 19/197,743

(22) Filed: May 2, 2025

Related U.S. Application Data
(60) Provisional application No. 63/642,091, filed on May 3, 2024.
(60) Provisional application No. 63/642,100, filed on May 3, 2024.

(51) Int. Cl. B65F 3/02; B60K 25/02

(52) U.S. Cl. CPC B65F 3/02; B60K 25/02; B60K 2025/026; B65F 2003/025

(57) ABSTRACT

A vocational vehicle includes a chassis, a body assembly, a prime mover, an energy storage device, and a peak shaving system. The peak shaving system is coupled to at least one of the chassis or the body assembly and includes a hydraulic pump, a motor-generator, and a controller. The motor-generator is coupled to the prime mover, the energy storage device, and the hydraulic pump. The controller is communicably coupled to the motor-generator and is configured to control the motor-generator to selectively supply power to the energy storage device or to power the hydraulic pump based on an operating condition of the vocational vehicle.

### CROSS-REFERENCE TO RELATED APPLICATIONS

The present application claims the benefit of and priority to U.S. Provisional Application No. 63/642,091, filed May 3, 2024, and U.S. Provisional Application No. 63/642,100, filed May 3, 2024, the entire contents of each of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a vocational vehicle including a chassis; a body assembly, a prime mover, an energy storage device, and a peak shaving system. The body assembly is coupled to the chassis. The prime mover is coupled to at least one of the chassis or the body assembly. The energy storage device is coupled to at least one of the chassis or the body assembly. The peak shaving system is coupled to at least one of the chassis or the body assembly and includes a hydraulic pump, a motor-generator, and a controller. The motor-generator is coupled to the prime mover, the energy storage device, and the hydraulic pump. The controller is communicably coupled to the motor-generator and is configured to control the motor-generator to selectively supply power to the energy storage device or to power the hydraulic pump based on an operating condition of the vocational vehicle.

Another embodiment relates to a peak shaving system for a vocational vehicle. The peak shaving system includes a hydraulic pump, a motor-generator, and a controller. The hydraulic pump is configured to power a hydraulic system onboard the vocational vehicle. The motor-generator is configured to couple the hydraulic pump to (i) a prime mover of the vocational vehicle and (ii) an energy storage device. The controller is communicably coupled to the motor-generator and is configured to: receive a function request, and control the motor-generator to selectively supply power to the energy storage device or to power the hydraulic pump based on the function request.

Another embodiment relates to a method of power allocation onboard a vocational vehicle including: receiving, by a controller, a function request associated with a hydraulic system of a vocational vehicle; determining, by the controller, a power demand of the hydraulic system based on the function request; and controlling, by the controller, a motor-generator that is coupled to a hydraulic pump of the hydraulic system and to an energy storage device to selectively supply power to the energy storage device or to power the hydraulic pump based on the power demand.

Another embodiment of the present disclosure relates to a vocational vehicle including a chassis, a prime mover, and an electric power take-off system. The chassis is coupled to a plurality of motive members. The prime mover is coupled to the chassis and is configured to power movement of the plurality of motive members. The electric power-take off system is coupled to the chassis and includes a motor and a hydraulic pump. The motor is rotationally coupled to the prime mover and is configured to be driven by the prime mover. The hydraulic pump is rotationally coupled to the motor and is configured to be driver by the motor.

Another embodiment relates to a refuse vehicle. The refuse vehicle includes a frame and a vehicle body coupled to the frame. The vehicle body includes an internal combustion engine and an electric power source. An internal combustion engine (ICE) axle is coupled to the internal combustion engine. An e-axle is coupled to the electric power source. A plurality of wheels is coupled to one or more of the ICE axle or the e-axle. Upon operation of the ICE axle, the e-axle is configured to operate under one or more prescribed operating modes.

In some embodiments, the one or more prescribed operating modes includes a regenerative mode, an idle mode, and/or an assist mode.

In some embodiments, the refuse vehicle includes a controller that is configured to apply an electrical load to the e-axle during operation in the regenerative mode, to operate the e-axle as an auxiliary axle in the idle mode, and/or to control the e-axle to power rotation of the wheels connected to the e-axle when the e-axle is in the assist mode.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a block diagram of a peak shaving system for the refuse vehicle of FIG. 1, according to an exemplary embodiment;

FIG. 3 is a block diagram of an electric power take-off system that may be used with the peak shaving system of FIG. 2, according to an exemplary embodiment;

FIG. 4 is a side view of a side-loading refuse vehicle, according to an exemplary embodiment;

FIG. 5 is a block diagram of a peak shaving system for the refuse vehicle of FIG. 4, according to an exemplary embodiment;

FIG. 6 is a flow diagram of a method of operating a peak shaving system for a vocational vehicle, according to an exemplary embodiment;

FIG. 7 is a side view of a refuse vehicle including a hybrid axle drive train, according to an exemplary embodiment; and

FIG. 8 is a side view of a refuse vehicle that includes a hybrid axle drivetrain, according to another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, embodiments described herein relate to systems and methods of peak shaving to reduce loads placed on an internal combustion engine of a vocational vehicle, such as a refuse vehicle, during periods of high energy usage. The system includes an electric motor-generator that is coupled between the internal combustion engine and a hydraulic pump used to provide hydraulic fluid to various subsystems onboard the vehicle. The electric motor is also electrically connected to an energy storage device (e.g., a battery, a capacitor, etc.). The system is configured to control operation of the electric motor-generator to generate power or drive the pump depending on an operating condition of the vehicle. For example, during periods of high energy usage, the peak shaving system may be configured to power the electric motor using the energy storage device, either on its own or to supplement power provided to the pump by the internal combustion engine (e.g., through the motor/generator). Conversely, during periods of low energy usage, the system may be configured to use the electric motor as a through shaft so that the pump is powered solely by the internal combustion engine or in addition to operating the electric motor as generator to charge the energy storage device. Such arrangements can balance load demand to the internal combustion engine during periods of high energy usage, enabling the use of smaller internal combustion engines to power the vehicle without impacting vehicle performance.

In some embodiments, the refuse vehicle alternatively, or additionally includes an electronic axle (e-axle) system including an e-axle that may power at least one set of wheels of the refuse vehicle. The e-axle system may be configured to control operation of the e-axle to augment power provided to the wheels by a prime mover (e.g., an internal combustion engine), or to fully power vehicle movement depending on vehicle operating conditions, as will be further described.

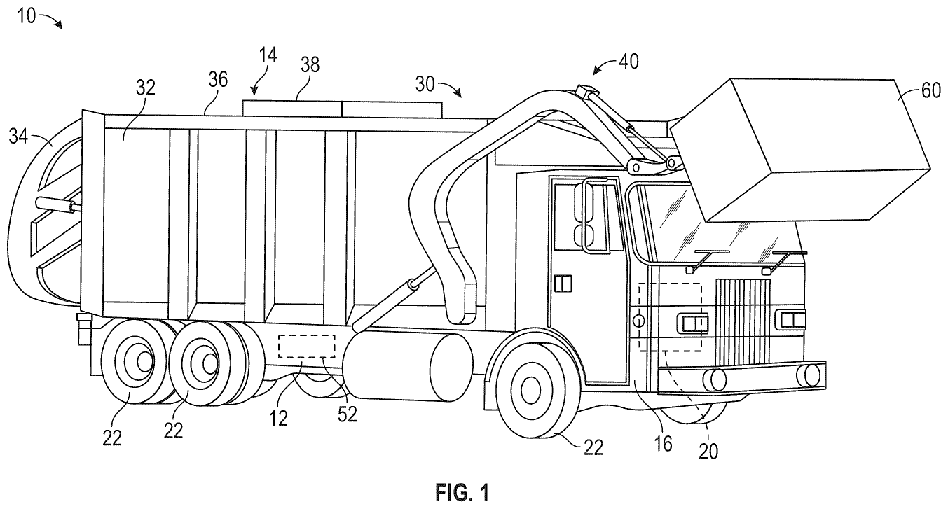

Referring to FIG. 1, a vocational vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the vehicle (e.g., computers, controllers, processors, etc.). The refuse vehicle 10 further includes a prime mover 20 coupled to the frame 12 at a position beneath the cab 16. The prime mover 20 is configured to provide power to a plurality of motive members, shown as wheels 22, and to other systems of the vehicle (e.g., a pneumatic system, a hydraulic system, an electric system, etc.). A pair of wheels 22 may be coupled to an axle that is coupled to, and supported by, the frame 12. The refuse vehicle 10 may include at least two axles. In some embodiments, the refuse vehicle 10 may include at least four axles, and may include five axles in various embodiments herein.

In some embodiments, the prime mover 20 is an internal combustion engine that is configured to generate power using one or more fuels. For example, the internal combustion engine may be configured to use a variety of fuels (e.g., gasoline, diesel, biodiesel, ethanol, natural gas, etc.), according to various exemplary embodiments. In some embodiments, the refuse vehicle 10 further includes at least one power take-off (PTO) that is configured to transmit power from the internal combustion engine to auxiliary components onboard the refuse vehicle 10, as will be further described. According to some embodiments, the refuse vehicle 10 may be in other configurations than shown in FIG. 1.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and on-board refuse container, in particular, defines a refuse compartment 30 (e.g., a collection chamber, etc.). In some embodiments, the body 14 includes a plurality of panels, shown as panels 32, a tailgate 34, and a cover 36 that together define the refuse compartment 30. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism may be used to support the tailgate 34 on the body 14. In some embodiments, the body 14 further includes a tailgate actuator to selectively open the tailgate 34 and to facilitate removal of refuse materials stored in the refuse compartment 30.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

In some embodiments, the refuse vehicle 10 also includes other application-specific hydraulic actuator systems to control vehicle operations. For example, the refuse vehicle 10 may include an ejector system including an ejector (e.g., a packer, a compactor, etc.) and an ejector actuator that is configured to move the ejector to compact loose refuse material within the refuse compartment 30, and/or to eject the refuse material through the tailgate 34. In some embodiments, the refuse vehicle 10 also includes a cover actuator to control movement of the top door 38 of the refuse vehicle 10. In some embodiments, the refuse vehicle 10 also includes a service lift actuator to move (e.g., tilt, etc.) the body 14 relative to the frame 12. In some embodiments, at least one of the actuators is a hydraulic actuator including a hydraulic cylinder driven by hydraulic pressure from one or more hydraulic pumps onboard the vehicle, as will be further described. In other embodiments, the refuse vehicle 10 includes additional, fewer, and/or different actuator systems.

Although embodiments disclosed herein are described with reference to a refuse vehicle, it should be understood that the peak shaving systems and methods of the present disclosure may also be used on other vocational vehicles including, but not limited to, cement trucks (e.g., mixer vehicles), dump trucks, and other on and off-highway vehicles having hydraulically actuated systems.

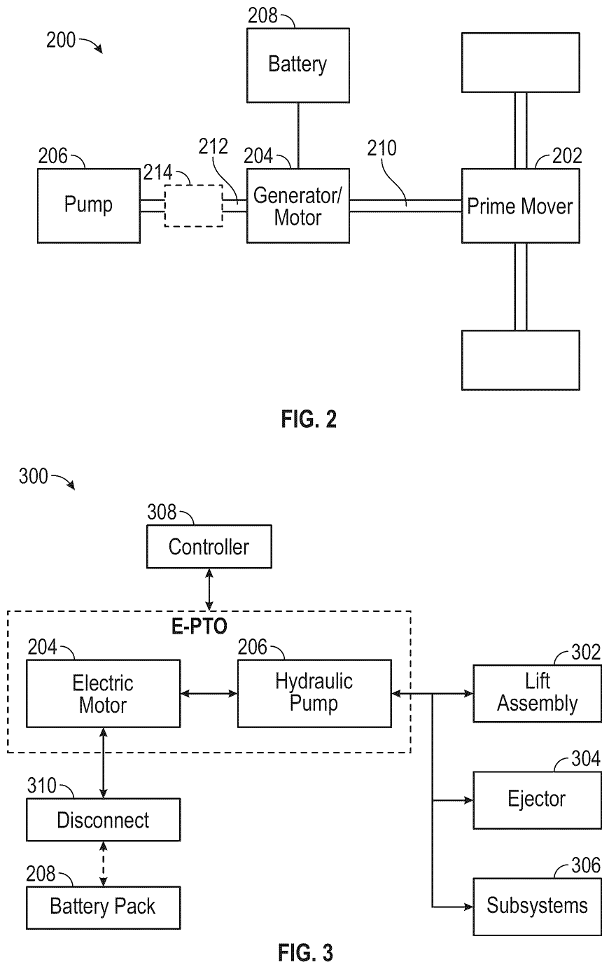

Referring to FIG. 2, the refuse vehicle 10 also includes a peak shaving system 200 that is configured to supplement power provided to auxiliary systems of the refuse vehicle (e.g., the lift assembly 40, etc.) by the prime mover 202 based on vehicle operating conditions. The peak shaving system 200 is also configured to provide load balancing from the prime mover 202 under different operating conditions, which can improve overall system efficiency. Such load-based power balancing can enable the use of a smaller prime mover to power the refuse vehicle, as will be further described.

The peak shaving system 200 includes a motor 204 (which may also be referred to as a motor-generator), a hydraulic pump 206, and an energy storage device 208. The peak shaving system 200 may also include a controller, as will be further described. In other embodiments, the peak shaving system 200 includes additional, fewer, and/or different components. For example, in some embodiments, the peak shaving system 200 includes only the motor 204 and the controller. Such embodiments can simplify retrofit of the peak shaving system 200 onto existing vehicles, depending on the vehicle configuration.

The motor 204 is rotationally coupled to the prime mover 202 (e.g., rotationally coupled directly to the prime mover 202) so as to be driven into rotation by the prime mover 202. In some embodiments, the vehicle (e.g., the prime mover 202) also includes a power take-off (PTO) and the motor 204 is rotationally coupled to the prime mover 202 by the PTO. In the embodiment of FIG. 2, the motor 204 includes a first drive element 210 (e.g., a first driveshaft, a first input shaft, etc.) that is rotationally coupled to the PTO. The motor 204 also includes a second drive element 212 (e.g., a second driveshaft, a second input shaft, etc.) that is rotationally coupled to the hydraulic pump 206. In such an embodiment, the hydraulic pump 206 may be driven by the second drive element 212 so that the hydraulic pump 206 rotates at the same rotational speed as the first drive element 210 and the PTO.

In some embodiments, the peak shaving system 200 further includes at least one clutch 214 configured to selectively couple the motor 204 to the hydraulic pump 206 and to control rotation of the hydraulic pump 206 independently from the PTO. Such an arrangement can increase system efficiency by preventing operation of the hydraulic pump 206, and circulation of hydraulic fluid, when no vehicle subsystems are needed (e.g., in between stops along a route, while the vehicle is in transit, etc.).

In the embodiment of FIG. 2, the motor 204 is an electric motor/generator (e.g., which may include a dynamo, an alternator, etc.) that combines an electric motor and a generator into a single unit. The motor 204 is electrically coupled to the energy storage device 208 so as to receive or provide energy to the energy storage device 208. The motor 204 is reconfigurable between a first operating state in which the motor 204 receives energy from the energy storage device 208 power rotation of the second drive element 212, and a second operating state in which the motor 204 provides energy to the energy storage device 208 for later use. In some embodiments, the motor 204 is a brushed direct current (DC) motor that is configured to output a DC voltage. In other embodiments, the motor 204 is a brushless motor configured to output an alternating current (AC) voltage. In such instances, the peak shaving system 200 may further include a voltage rectifier (e.g., an AC to DC converter, etc.) to provide power from the motor 204 to the energy storage device 208.

The hydraulic pump 206 is rotationally coupled to the motor 204 by the second drive element 212. The hydraulic pump 206 is configured to provide pressurized hydraulic fluid (e.g., oil, etc.) to a hydraulic system. Referring again to FIG. 1, the hydraulic pump 206 may be configured to provide pressurized hydraulic fluid to the lift assembly 40. In some embodiments, the hydraulic pump 206 is a variable displacement pump that is configured to adjust the amount of hydraulic fluid being pumped through the system and/or the pressure of the hydraulic fluid. For example, the hydraulic pump 206 may be one of a variable displacement axial piston pump that uses a swashplate to vary the piston stroke and displacement (e.g., a flow rate of hydraulic fluid, etc.), a variable displacement vane pump that is configured to adjust the eccentricity of a rotor of the hydraulic pump to change the displacement, or a variable displacement radial piston pump that includes a tilting swashplate or cam mechanism to adjust piston stroke and displacement of hydraulic fluid. Such an arrangement can, beneficially, enable control of the hydraulic pump 206 to vary hydraulic system pressure based on an operating condition of the vehicle or user commands, which can increase system efficiency.

The energy storage device 208 is coupled to the chassis of the vehicle or a body of the vehicle. In some embodiments, the energy storage device 208 includes a battery pack that provides power to a motor that produces rotational power to drive the refuse vehicle. In the embodiment of FIG. 2, the energy storage device 208 is electrically coupled to the motor 204 and is configured to receive and store energy produced by the motor 204, and also to power operation of the motor 204 (such as when the motor 204 is used to supplement power provided by the prime mover to the hydraulic pump 206). In other embodiments, the energy storage device 208 includes a capacitor. The energy storage device 208 can be used to provide power to different subsystems on the vehicle.

Referring to FIG. 3, in some embodiments, the motor 204 and/or the hydraulic pump 206 together define an electric power take-off system (E-PTO) 300 that is coupled to the chassis (e.g., the frame 12 of FIG. 1). For example, the peak shaving system may form part of an E-PTO module including a housing that encloses components of the peak shaving system. The E-PTO system 300 is configured to receive electrical power from the energy storage device 208 and/or other power sources and to convert the electrical power to hydraulic power for different subsystems on the refuse vehicle. In some embodiments, the E-PTO system 300 receives electrical power from the energy storage device 208 and provides the electrical power to the motor 204. In such embodiments, the motor 204 drives the hydraulic pump 206 that provides pressurized hydraulic fluid to different vehicle subsystems, such as a lift assembly 302 (e.g., the lift assembly 40 of FIG. 1), an ejector system 304, or other subsystems 306 (e.g., the tailgate, etc.).

In some embodiments, the E-PTO system 300 includes an E-PTO controller 308. The E-PTO controller 308 may be configured to monitor various systems within the refuse vehicle, including the E-PTO system 300. The E-PTO controller 308 may be configured to receive data from sensors (not shown) within the system, compare the data to expected values under normal operating conditions, adjust the operation parameters of components of the system, and determine if a critical operating condition exists based on the sensor data. Further, the E-PTO controller 308 may be configured to shut down the system and/or the refuse vehicle in response to detecting a critical operating condition.

In the embodiment of FIG. 3, the E-PTO controller 308 is communicably coupled to the motor 204 and the hydraulic pump 206 and is configured to control operation of the motor 204 and the hydraulic pump 206. In some embodiments, the E-PTO controller 308 is configured to control load balancing between a prime mover of the vehicle and the motor 204. For example, the E-PTO controller 308 may be configured to control operation of the motor 204 between a first operating state in which the motor 204 receives energy from the energy storage device 208 to power movement of the hydraulic pump 206, and a second operating state in which the motor 204 provides energy to the energy storage device 208. In the first operating state, the E-PTO controller 308 controls the motor 204 to supplement power provided by the prime mover to the hydraulic pump 206. In the second operating state, the E-PTO controller 308 controls the motor 204 to generate power for storage and later use.

In some embodiments, the E-PTO controller 308 is configured to reconfigure the motor 204 between the first operating state and the second operating state, and to vary the amount of power supplied to or provided by the energy storage device 208 based on at least one operating condition of the vehicle, such as based on power demand of one or more hydraulic systems, as will be further described. In some embodiments, the E-PTO controller 308 is also configured to coordinate operation of the hydraulic pump 206 and the motor 204, based on the at least one operating condition.

In some embodiments, the refuse vehicle further includes a disconnect 310 positioned between the energy storage device 208 and the E-PTO system 300 to allow different vehicle subsystems (e.g., the ejector system 304, the lift assembly 302 and/or other subsystems 306, etc.) to be decoupled and de-energized from the energy storage device 208. For example, the E-PTO controller 308 may be configured to cause the disconnect 310 to be decoupled and de-energized from the energy storage device 208 in the event of system malfunction.

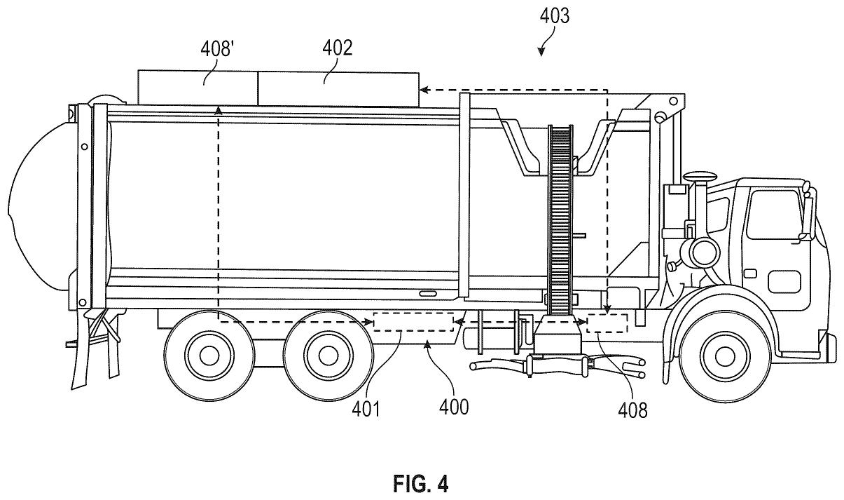

Referring to FIG. 4, a peak shaving system 400 for another type of refuse vehicle, shown as vehicle 403, includes a plurality of E-PTO systems, shown as a first E-PTO system 401 and a second E-PTO system 402. The first E-PTO system 401 and the second E-PTO system 402 are configured to control pressurization of hydraulic systems onboard the refuse vehicle 403. In the embodiment of FIG. 4, the first E-PTO system 401 and the second E-PTO system 402 are each coupled to a single energy storage device 408 (e.g., a battery pack, a capacitor, etc.). Such an arrangement can enable operation of at least one hydraulic system onboard the vehicle 403 independent from the first E-PTO system 401 and the prime mover. In other embodiments, the peak shaving system 400 includes a plurality of energy storage devices to power the first E-PTO system 401 and/or the second E-PTO system 402 (e.g., second energy storage device 408′).

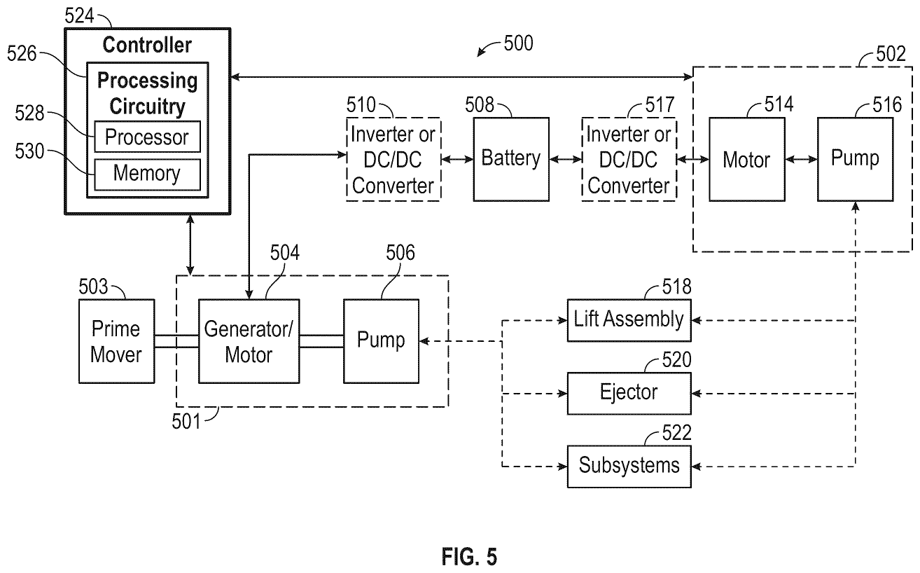

Referring to FIG. 5, a peak shaving system 500 that may be used as the peak shaving system 400 of FIG. 4 is shown, according to an exemplary embodiment. The E-PTO system includes a first E-PTO system 501 and a second E-PTO system 502 that are each electrically coupled to a shared energy storage device 508.

In some embodiments, the first E-PTO system 501 is configured in the same or a similar manner as the E-PTO system 300 described with reference to FIG. 3. In the embodiment of FIG. 5, the first E-PTO system 501 includes a prime mover 503, a first motor 504, and a first hydraulic pump 506. The first motor 504 is electrically coupled to the energy storage device 508 (e.g., a battery pack, a capacitor, etc.) via a first power management device 510. The first power management device 510 is configured to adjust a voltage and/or current type of power transferred between the first motor 504 and the energy storage device 508.

In some embodiments, the first power management device 510 includes a power conditioner between the first motor 504 and the energy storage device 508 that is configured to stabilize (e.g., smooth out, etc.) voltage and/or current levels, suppress electrical noise, and/or protect connected devices from power surges and other electrical disturbances. In some embodiments, the first power management device 510 includes an inverter that is configured to convert DC power into AC power. In other embodiments, the first power management device 510 includes a DC-to-DC converter that is configured to adjust voltage levels between the energy storage device 508 and the first motor 504 (and vice versa). In some embodiments, the first power management device 510 is integrated into the first motor 504 or the energy storage device 508.

In some embodiments, the peak shaving system 500 does not include the first power management device 510 and the first motor 504 is configured to produce power at the required voltage and current levels for the energy storage device 508. For example, the first power management device 510 may be a brushless DC motor that is configured to produce 48 V DC power to the energy storage device 508 operating at the same voltage levels. In other embodiments, the first power management device 510 is configured to automatically determine incoming power levels and to adjust a current and/or voltage of the power provided depending on the incoming power levels, and/or based on specifications for the energy storage device 508.

The second E-PTO system 502 includes a second motor 514 and a second hydraulic pump 516 that is rotatably coupled to the second motor 514. In some embodiments, the second E-PTO system 502 is part of an E-PTO module (e.g., an E-PTO pod, etc.) including a housing (e.g., an enclosure, etc.) that is configured to support the second motor 514 and the second hydraulic pump 516 onboard the vehicle. For example, referring to FIG. 4, the second E-PTO system 402 may be housed within an enclosure that is connected to a roof of the vehicle body, above the vehicle cab, on the tailgate, or in any other location along the refuse vehicle body and/or chassis. In at least one embodiment, the E-PTO module (e.g., the housing and components therein) is detachably coupled to the vehicle, which can enable removal and replacement of the E-PTO system without having to disassemble different parts of the vehicle. For example, the housing for the E-PTO module may include disconnects to enable electrical isolation of the second motor 514 and the second hydraulic pump 516 from the vehicle and/or the energy storage device 508.

The second E-PTO system 502 (i.e., the second motor 514 and the second hydraulic pump 516) are configured to operate independently from the first E-PTO system 501, which can increase efficiency of the vehicle's hydraulic system relative to embodiments in which the hydraulic system is powered by the first E-PTO system 501 alone. For example, including the second motor 514 and the second hydraulic pump 516 can enable complete shutdown of at least portions of the vehicle's hydraulic system during periods of non-use, such as between stops along a refuse collection route, while operating at least certain subsystems of the vehicle's hydraulic system at idle or elevated hydraulic pressure. Such an arrangement can enable complete shut-down of a lift assembly 518 of the vehicle during transit of the refuse vehicle between neighborhoods, for example, while enabling continued operation of the ejector system 520 so that refuse material may be continually compacted during a transit period associated with the transit.

Referring still to FIG. 5, the second motor 514 is electrically coupled to the energy storage device 508 (e.g., a battery pack, a capacitor, etc.) via a second power management device 517, which may operate the same as or similar to the first power management device 510.

For example, in some embodiments, the second power management device 517 includes a power conditioner between the second motor 514 and the energy storage device 508 that is configured to stabilize (e.g., smooth out, etc.) voltage and/or current levels, suppress electrical noise, and/or protect connected devices from power surges and other electrical disturbances. In some embodiments, the second power management device 517 includes an inverter that is configured to convert DC power into AC power. In other embodiments, the second power management device 517 includes a DC-to-DC converter that is configured to adjust voltage levels between the energy storage device 508 and the second motor 514 (and vice versa). In some embodiments, the second power management device 517 is integrated into the second motor 514 or the energy storage device 508.

In some embodiments, the peak shaving system 500 does not include the second power management device 517 and the second motor 514 is configured to produce power at the required voltage and current levels for the energy storage device 508. For example, the second power management device 517 may be a brushless DC motor that is configured to produce 48 V DC power to the energy storage device 508 operating at the same voltage levels. In other embodiments, the second power management device 517 is configured to automatically determine incoming power levels and to adjust a current and/or voltage of the power provided depending on the incoming power levels, and/or based on specifications for the energy storage device 508.

Referring still to FIG. 5, the controller 524 is communicably coupled to the first E-PTO system 501 and the second E-PTO system 502 and is configured to control operation of the first E-PTO system 501 and the second E-PTO system 502 based on at least one operating condition of the vehicle. For example, the controller 524 may be configured to control the first motor 504 between a first operating state and a second operating state based on at least one vehicle condition. The controller 524 is also configured to coordinate operation of the first hydraulic pump 506 with the first motor 504. In some embodiments, the controller 524 is also configured to control operation of the second motor 514 based on at least one vehicle condition, such as based on a function request made by an operator.

As used herein, “at least one vehicle condition” refers to operating condition(s) of the vehicle. For example, the at least one vehicle condition may include a function request associated with user inputs to actuate one or more hydraulic systems onboard the vehicle, such as a request to operate the lift assembly 518, the ejector system 520, and/or another subsystem 522 onboard the vehicle. The function request may cause a power demand of the hydraulic system to increase. For example, the function request may require an increase in hydraulic pressure for one or more hydraulic systems, and/or activation of multiple hydraulic systems simultaneously. In some embodiments, “at least one vehicle condition” refers to a location of the vehicle relative to a work site (e.g., a residential area, a commercial business, etc.) or another operating condition of the vehicle that may be sensed or transmitted to the controller 524.

The controller 524 includes processing circuitry 526 (e.g. one or more processing circuits) including a processor 528 and memory 530. The memory 530 may include a computer-readable, non-transitory storage medium including instructions that, when executed by the processor 528 (e.g., one or more processors), cause the processor 528 to execute any one or combination of the control methods described herein. In some embodiments, the controller 524 is part of a standalone control module and/or control circuit that is included as part of the E-PTO system. In other embodiments, at least portions of the controller 524 may be integrated with a vehicle controller (e.g., an engine control unit, etc.).

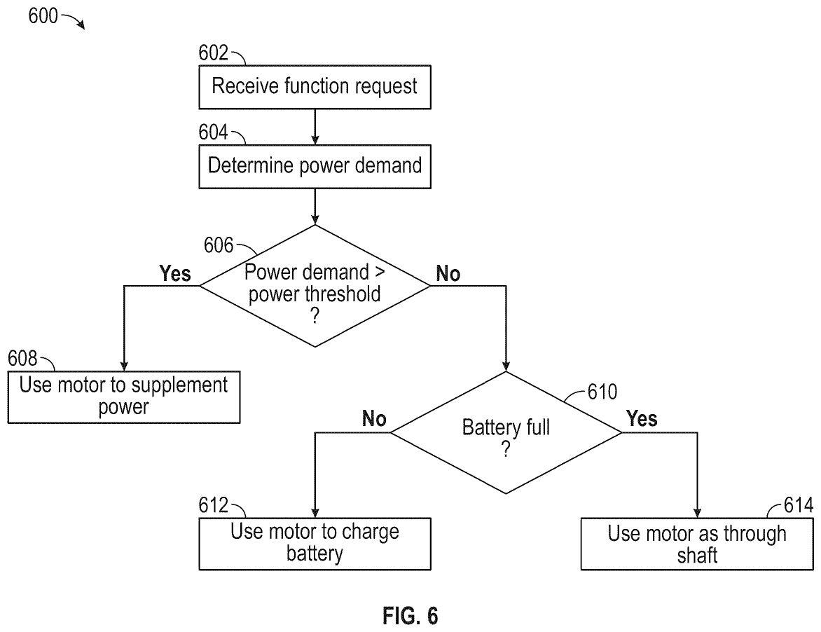

Referring to FIG. 6, a method 600 for controlling a peak shaving system, such as via the controller 524, is shown, according to an exemplary embodiment. In other embodiments, the method 600 may include additional, fewer, and/or different operations.

At 602, the controller (e.g., the controller 524, etc.) receives a function request associated with operation of a vehicle (e.g., a refuse vehicle, a vocational vehicle, etc.). In some embodiments, operation 602 includes receiving a user input requesting operation of a hydraulic system (e.g., a hydraulic actuator) onboard the vehicle. For example, operation 602 may include receiving a user input from a user interface onboard a refuse vehicle requesting actuation of a lift system/assembly, an ejector system, or another vehicle subsystem. In other embodiments, operation 602 includes receiving data from other controllers onboard the vehicle or from sensors configured to measure changes in vehicle operating conditions, such as hydraulic pressure sensors, etc. In some embodiments, responsive to the absence of a function request or need for hydraulic system operation, the controller may be configured to operate a hydraulic pump (e.g., the hydraulic pump 406 of FIG. 4, the first hydraulic pump 506 of FIG. 5) to reduce fluid displacement through the pump and to reduce energy consumption. In other embodiments, the controller may be configured to control a clutch to uncouple the motor from the pump, which can significantly reduce any parasitic loads on the prime mover during transit operations, etc.

At 604, the controller determines a power demand based on the function request. The power demand may be indicative of a power and/or load (e.g., horsepower, kW, etc.) required to perform the function request. In some embodiments, operation 604 includes determining an approximate power consumption of one or more hydraulic systems based on experimental data stored in memory. For example, operation 604 may include accessing a lookup table including list of power consumption values associated with different function requests or combinations of function requests. In some embodiments, operation 604 may include calculating an overall power demand based on individual values of power consumption resulting from multiple function requests. In some embodiments, operation 604 includes determining a real-time power demand based on sensor data from sensors onboard the vehicle, such as based on a weight of the refuse container being lifted, a hydraulic pressure of the hydraulic fluid within the hydraulic system during actuation, and other sensed real-time vehicle operating conditions.

At 606, the controller compares the power demand with at least one power threshold. The power threshold may be a power/load level at which a prime mover (e.g., an internal combustion engine, etc.) is unable to power the function request on its own. In other embodiments, the power threshold is power value above which the efficiency of the prime mover decreases below an engine efficiency threshold. In some embodiments, operation 606 includes retrieving at least one power threshold value stored in memory or via a telematics interface onboard the vehicle that is configured to communicate with a fleet manager or other vehicle management service.

In some embodiments, operation 606 includes comparing the power demand with a plurality of power thresholds and determining a desired operating configuration of the peak shaving system based on the comparisons. In some embodiments, operation 606 includes determining weighting parameters based on the comparison(s), and/or based on an overrun associated with how much the power demand exceeds the power threshold(s).

At 608, responsive to determining that the power demand satisfies (e.g., is greater than, equal to, or within a threshold value of) the power threshold, the controller controls a motor that is rotationally coupled to the prime mover (e.g., the motor 404 of FIG. 4, the first motor 504 of FIG. 5, etc.) in a first operating state. In some embodiments, operation 608 includes controlling the motor to supplement power provided by the prime mover to a hydraulic pump (e.g., the hydraulic pump 406 of FIG. 4, the first hydraulic pump 506 of FIG. 5, etc.) that is rotationally coupled to the motor. In some embodiments, operation 608 includes transmitting a control signal to the motor and/or an inverter controlling motor torque based on the desired operating condition determined in operation 606. In other embodiments, operation 608 includes transmitting a control signal to the motor based on the weighting parameter(s) and/or overrun determined in operation 606. Among other benefits, such operations can provide load balancing between the motor (and the energy storage device/battery pack) and the prime mover. Such operations can also maintain more steady operation of the prime mover within smaller bands of rotational speeds, which can increase overall system efficiency and reduce fuel consumption.

In some embodiments, operation 608 also includes controlling the hydraulic pump based on the power demand. For example, operation 608 may include transmitting a control signal to the hydraulic pump to vary a displacement of the hydraulic pump based on the power demand, and to achieve a hydraulic pressure threshold within the hydraulic system that is necessary to satisfy the power demand based on a rotational speed of the prime mover and the motor.

At 610, responsive to determining that the power demand is less than the power threshold, the controller determines a condition of the energy storage device (e.g., the battery pack, etc.). In some embodiments, operation 610 includes comparing a state of charge (e.g., a voltage, etc.) of the energy storage device to a threshold state of charge in memory to determine whether the energy storage device needs to be recharged.

At 612, responsive to determining that the energy storage device is not fully charged, or is below a threshold state of charge, the controller controls the motor that is rotationally coupled to the prime mover in a second operating state. In some embodiments, operation 612 includes applying a resistive load to the motor so that the motor functions as an electric generator to provide energy to the energy storage device.

At 614, responsive to determining that the energy storage device is fully charged, or is at a state of charge that is greater than or equal to the threshold state of charge, the controller controls the motor as a through-shaft so that energy provided by the prime mover to the motor passes through the motor to the hydraulic pump. In such circumstances, the motor functions as an extension of the drive element (e.g., driveshaft, etc.) between the prime mover and the hydraulic pump. In some embodiments, operation 614 also includes controlling the hydraulic pump based on the power demand. For example, operation 614 may include transmitting a control signal to the hydraulic pump to vary a displacement of the hydraulic pump based on the power demand, and to achieve a hydraulic pressure threshold within the hydraulic system that is necessary to satisfy the power demand based on a rotational speed of the prime mover and the motor.

In some embodiments, the refuse vehicle may additionally, or alternatively, include an electronic axle (e-axle) system that is configured to directly power at least one set of wheels of the refuse vehicle. As described above with respect to FIG. 1, the refuse vehicle includes a frame and a vehicle body coupled to the frame. The vehicle also includes a prime mover (e.g., an internal combustion engine). The refuse vehicle may also include an electric power source that is separate from the internal combustion engine, which may include an energy storage device such as a battery pack. The vehicle may include an internal combustion engine (ICE) powered axle that is coupled to and powered directly by the internal combustion engine. The e-axle may be coupled to the electric power source. The e-axle is configured to operate under one or more prescribed modes based on operating conditions of the refuse vehicle.

Referring still to FIG. 1, according to an at least one embodiment, the prime mover 20 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10.

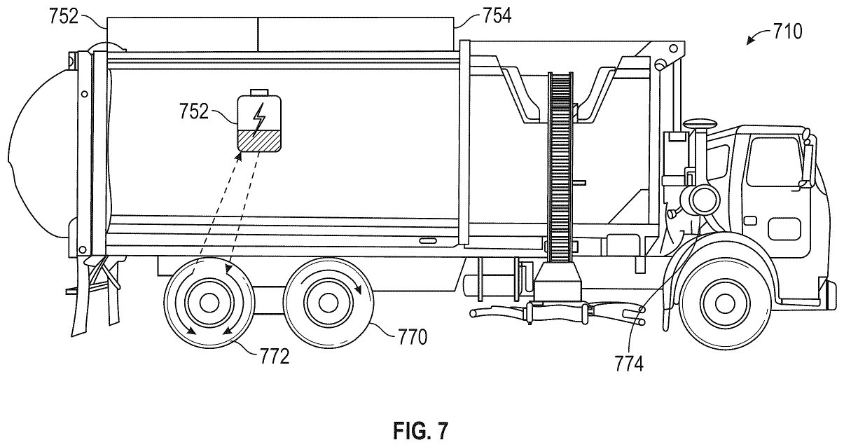

Referring to FIG. 7, a refuse vehicle 710 is shown that includes a prime mover, shown as internal combustion engine (ICE) axle 774 (e.g., an axle powered by the internal combustion engine), and an e-axle 772. The ICE axle 770 may be coupled to an internal combustion engine powered by a fuel such as diesel, compressed natural gas (CNG), hydrogen, e-fuels, synthetic fuels, etc. The e-axle 772 may be coupled to an electric power source such as batteries (e.g., the battery pack 752), a hydrogen fuel cell, a capacitor, etc.

The e-axle system may be configured to operate the e-axle 772 in one or more prescribed modes based on operating conditions (and when the refuse vehicle 710 is operating at least partially under ICE power). For example, the e-axle system may be configured to operate the e-axle 772 in a regenerative mode, an idle mode, or an assist mode. In the regenerative mode, the e-axle system is configured to supply electricity from the e-axle 772 (e.g., generated by movement of the wheels connected to the e-axle) to charge the power source. For example, the e-axle system (e.g., an e-axle controller, the E-PTO controller, the vehicle controller, the engine control unit) may be configured to reconfigure the e-axle 772 to operate as a generator to charge the power source (e.g., continuously, semi-continuously, etc.) while power is being provided to drive the vehicle by the ICE axle 770, or to apply regenerative braking. The e-axle system may be configured to apply an electrical load to the e-axle 772 to charge the power source in such operating conditions, which may cause torque opposing the rotation of one or more of the wheels, which may be used to brake the refuse vehicle 710.

The e-axle system may also be configured to operate the e-axle in an idle mode, in which the e-axle system controls the e-axle 772 to operate as an auxiliary axle to provide support or other functionality to the refuse vehicle 710 (e.g., an idle mode in which no power is supplied to or from the e-axle, a freewheeling mode, etc.).

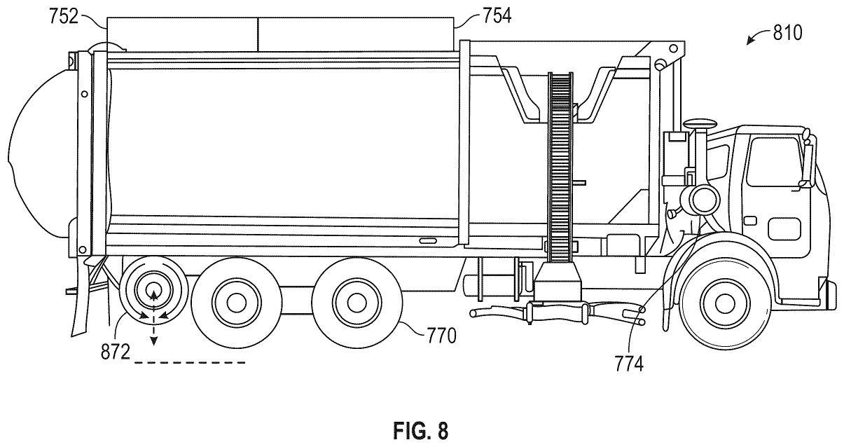

Referring to FIG. 8, another refuse vehicle 810 that includes an e-axle 872 is shown, according to an embodiment. in some embodiments, the e-axle 872 may act as a pusher axle or a tag axle, etc., and as such may be configured to increase the refuse vehicle 810 payload while enhancing weight distribution. In the idle mode, the e-axle 872 may be stationary, or as shown in FIG. 8, and may be lifted off of a ground surface (e.g., lifted with airbags, etc.). In some embodiments, the idle mode of the e-axle 872 may be controlled via electric motor control.

The e-axle system may also be configured to control the e-axle to operate in the assist mode, to provide power to the e-axle 872 from the batteries to supplement power from the ICE-axle, or to operate as a standalone source of drive power. For example, torque used for the rotation of one or more of the wheels may be provided by the motor when using electrical energy from the battery pack 752. In some embodiments, the e-axle 872 operating in the assist mode may be configured to power the refuse vehicle 10 on its own. The e-axle system may be configured to control operation of the e-axle 872 based on operating conditions, in a similar manner as described with respect to the E-PTO system above. For example, under low power consumption conditions, such as when the refuse vehicle is traveling between work sites, the e-axle system may be configured to operate the e-axle 872 in the regenerative mode to charge the battery pack onboard the refuse vehicle. Under high power consumption conditions, such as when the vehicle is operating withing a work site (e.g., along a pick-up route in a residential area), the e-axle system may be configured to operate the e-axle 872 in the assist mode so that more power from the ICE system can be used to power refuse vehicle functions (e.g., the lift system, the packer/ejector, etc.).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vocational vehicles as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A vocational vehicle comprising:
a chassis;
a body assembly coupled to the chassis;
a prime mover coupled to at least one of the chassis or the body assembly;
an energy storage device coupled to at least one of the chassis or the body assembly; and
a peak shaving system coupled to at least one of the chassis or the body assembly, the peak shaving system comprising:
a hydraulic pump;
a motor-generator coupled to the prime mover, the energy storage device, and the hydraulic pump; and
a controller communicably coupled to the motor-generator, the controller configured to control the motor-generator to selectively supply power to the energy storage device or to power the hydraulic pump based on an operating condition of the vocational vehicle.

2. The vocational vehicle of claim 1, further comprising a power take-off configured to selectively couple the motor-generator to the prime mover.

3. The vocational vehicle of claim 1, wherein the motor-generator includes a first drive element that is rotationally coupled to the prime mover, and a second drive element that is rotationally coupled to the hydraulic pump, and so that the hydraulic pump rotates at a same rotational speed as the first drive element in at least one operating mode.

4. The vocational vehicle of claim 1, wherein the controller is configured to control operation of the motor-generator between a first operating state in which the motor-generator receives energy from the energy storage device to power movement of the hydraulic pump, and a second operating state in which the motor-generator provides energy to the energy storage device.

5. The vocational vehicle of claim 1, further comprising:
an electric power take-off system coupled to the energy storage device, the electric power take-off system comprising:
a motor configured to be powered by the energy storage device; and
a second hydraulic pump coupled to the motor.

6. The vocational vehicle of claim 5, wherein the electric power take-off system is configured to operate independently from the peak shaving system.

7. The vocational vehicle of claim 1, wherein the peak shaving system further comprises a clutch that couples the motor-generator to the hydraulic pump.

8. The vocational vehicle of claim 1, wherein the operating condition is indicative of an anticipated power demand associated with operation of a hydraulic actuator onboard the vocational vehicle.

9. The vocational vehicle of claim 1, wherein the controller is further configured to:
receive the operating condition as a function request to actuate a hydraulic system onboard the vocational vehicle; and
control the motor-generator to selectively supply power to the energy storage device or to power the hydraulic pump based on the function request.

10. The vocational vehicle of claim 1, wherein the hydraulic pump is a variable displacement pump.

11. A peak shaving system for a vocational vehicle, the peak shaving system comprising:
a hydraulic pump configured to power a hydraulic system onboard the vocational vehicle;
a motor-generator configured to couple the hydraulic pump to (i) a prime mover of the vocational vehicle and (ii) an energy storage device; and
a controller communicably coupled to the motor-generator, the controller configured to:
receive a function request; and
control the motor-generator to selectively supply power to the energy storage device or to power the hydraulic pump based on the function request.

12. The vocational vehicle of claim 11, wherein the controller is configured to control operation of the motor-generator between a first operating state in which the motor-generator receives energy from the energy storage device to power movement of the hydraulic pump, and a second operating state in which the motor-generator provides energy to the energy storage device.

13. The peak shaving system of claim 11, wherein the controller is further configured to:
determine a power demand based on the function request;
control the motor-generator to power the hydraulic pump when the power demand satisfies a power threshold; and
control the motor-generator to supply power to the energy storage device when the power demand does not satisfy the power threshold.

14. The peak shaving system of claim 13, wherein the controller is further configured to control the hydraulic pump to adjust at least one of a pressure or a flow rate of hydraulic fluid provided by the hydraulic pump based on the power demand.

15. The peak shaving system of claim 11, wherein the controller is further configured to:
determine a power demand based on the function request;
receive data indicative of a state of charge of the energy storage device; and
control the motor-generator to supply power to the energy storage device when the power demand is less than a power threshold and when the data indicates that the state of charge is less than a threshold state of charge.

16. The peak shaving system of claim 11, wherein the motor-generator includes a first drive element that is rotationally coupled to the prime mover, and a second drive element that is rotationally coupled to the hydraulic pump, and so that the hydraulic pump rotates at a same rotational speed as the first drive element in at least one operating mode.

17. The peak shaving system of claim 11, further comprising a clutch that couples the motor-generator to the hydraulic pump.

18. The peak shaving system of claim 11, wherein the energy storage device includes a battery pack.

19. A method comprising:
receiving, by a controller, a function request associated with a hydraulic system of a vocational vehicle;
determining, by the controller, a power demand of the hydraulic system based on the function request; and
controlling, by the controller, a motor-generator that is coupled to a hydraulic pump of the hydraulic system and to an energy storage device to selectively supply power to the energy storage device or to power the hydraulic pump based on the power demand.

20. The method of claim 19, wherein the vocational vehicle is a refuse vehicle, wherein receiving the function request comprises receiving a user input from a user interface requesting operation of at least one of a lift system of the refuse vehicle or an ejector system of the refuse vehicle.
